(19) United States
(12) Patent Application Publication
(10) Pub. No.: US 2026/0267825 A1
(43) Pub. Date: Sep. 10, 2026

(54) AUTOMATED SUB-SLICING AND INTELLIGENT PARALLELISM OF A HIGH DENSITY FILESYSTEM

(71) Applicant: Dell Products L.P., Round Rock, TX (US)

(72) Inventors: Aneesh Kumar Gurindapalli, Vijayawada (IN); Soumen Acharya, Bangalore (IN); Sunil K. Yadav, Bengaluru (IN); Upanshu Singhal, Bangalore (IN); Sunil Kumar, Bangalore (IN)

(21) Appl. No.: 19/075,609

(22) Filed: Mar. 10, 2025

(51) Int. Cl. G06F 16/172; G06F 11/1446

(52) U.S. Cl. CPC G06F 16/172; G06F 11/1466

(57) ABSTRACT

One example method includes while an incremental backup of files is being performed, scanning, by a slicer, a directory that includes the files, keeping a count of the files that have been scanned, determining, by the slicer, when a file size threshold, or a file number threshold, has been exceeded, and when the file size threshold, or the file number threshold, has been exceeded, recording, by the slicer, as a sub-slice, the file(s) that were the basis for the determination that one of those thresholds had been exceeded.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to data protection. More particularly, at least some embodiments relate to systems, hardware, software, computer-readable media, and methods, for slicing data so as to enable incremental, parallelized, backups of the data.

### BACKGROUND

A conventional approach to data slicing employs a ‘slicer’ that creates a pre-defined fixed slice size, for example, a slice size of 200 GB, or a slice that has 1 million files, and that slice size remains the same for all types of data residing on a filesystem participating in a data backup. This approach creates the slices, and a backup agent uses those slices in the same manner as they were created initially.

This conventional slicer with its fixed slice sizes works well with a balanced filesystem tree where files and folders are distributed evenly on the filesystem, and/or where the average file size is about equal across the folders of the system. There are many customers who have some applications generating a large amount of file data in very few folders and such customers may have many millions of file, for example, 50-100 million files in a single folder, or a few folders. File sizes in these folders can be very small, such as 4 -16 KB files, or as large as 1-10 TB. These types of datasets present multiple challenges for conventional slicers and slicing approaches, some examples of which are discussed below.

A conventional slicer takes an indefinite amount of time to scan the files more then 2-3 million in a single folder. Many times, the system cache chokes due to the large number of files, and the slicer is unable to continue scanning. As another example, a conventional approach may only generate only 1 or 2 slices for millions of files, or for files with a very large size that reside in a single, or only a few folders.

Conventional approaches, at least by virtue of their minimal number of slices, and fixed slice size, are unable to use a parallel backup approach. As such, conventional slicing methods and mechanisms impair the speed and effectiveness of data backups. More particularly, conventional approaches result in a very low network read throughput for dense filesystems, and also result in relatively high backup wall clock times.

Further a conventional approach may scan through a complete filesystem based on the pre-defined file size and number of files for a slice. With this approach, a directory with multi million files or few files with 100s of GB in a single folder, the slicer generates single slice for it. However, this slicer cannot split files in a single folder and cannot split it in logical entry by accommodating list of files per slice, for example. Further, since only a single slice data is read, and with only 1 stream results in a very low throughput, and a high backup wall clock time.

Moreover, due to the nature of the dataset, conventional approaches are not able to address the file scale and typically result in backup hung or backup failure state. A conventional slicer also scans the files in this kind of dataset with single thread. Finally, conventional approaches require a data mover to scan the files for each slice again during backup and results in additional system overhead and slow performance.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a schema for data slicing, according to one embodiment.

FIG. 2 discloses aspects of an approach for slicing high density folders (HDF), according to one embodiment.

FIG. 3 discloses aspects of a method for creating slices, according to one embodiment.

FIG. 4 discloses aspects of an approach for sub-slicing low density folders (LDF), according to one embodiment.

FIG. 5 discloses aspects of an approach for backing up data including handling a sub-slice as a slice, according to one embodiment.

FIG. 6 discloses an example slice object contract, according to one embodiment.

FIG. 7 discloses an example schema that may be shared with a filesystem, according to one embodiment.

FIG. 8 discloses an example schema for high density folder scan during a gen0 crawl of the folder, according to one embodiment.

FIG. 9 discloses an example query for creating a slice of an HDF, post crawling, according to one embodiment.

FIG. 10 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to data protection. More particularly, at least some embodiments relate to systems, hardware, software, computer-readable media, and methods, for slicing data so as to enable incremental, parallelized, backups of the data.

Various embodiments, such as methods and schemas, are disclosed herein for slicing data so as to enable incremental, and parallelized, data backups. The size and/or number of data slices, and/or sub-slices of data slices, created may be dynamically and automatically varied over time, and possibly in real time, during an incremental backup, based on one or more considerations such as, but not limited to, file sizes, file distribution across a file system or other structure, the number of backup threads available, and backup constraints including the amount of data to be backed up, communication bandwidth, and latency between a backup source and a backup target.

One embodiment of a method may be performed during an incremental backup, in which the delta, or data changes, are distributed across sub-slices in such a way that the order of inode, or file name, sequencing is maintained. During the incremental backup, a method for dynamic sub-slicing and intelligent parallelism, according to one embodiment, may be performed that comprises operations including, but not limited to: while a slicer is scanning a directory, keeping, by the slicer, a count of the number of files identified, and if the number of files becomes exceeds a threshold, recording, by the slicer, those files as a sub-slice in a cache or a temporary database; additionally, or alternatively, while the slicer is scanning the directory, if any file identified in the scanning has a size greater than a specified default slice size, recording, by the slicer, that file as a separate sub-slice in a cache or a temporary database; by a data mover agent, processing the sub-slice(s) and, when the data mover agent, finds any sub-slice, files of those sub-slices are read by the data mover agent from the cache or temporary database, rather than the data mover agent performing another scan of the directory; backing up, by the data mover agent, the sub-slices in parallel with a same number of parallel streams as selected by a user; and, by the data mover agent, intelligently maintaining the desired parallelism by running only those slices and sub-slices in parallel as desired by the user.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that slices and/or sub-slices may be created and used to support parallel backup streams. In an embodiment, a number of threads to create sub-slices may be computed dynamically and automatically while an incremental backup, of the data from which the sub-slices originate, is being performed. An embodiment may employ inode numbers or filename sequencing in a lexical order to identify the deltas to be backed up as part of an incremental backup process. Various other advantages of one or more example embodiments will be apparent from this disclosure.

### A. Overview of aspects of an embodiment

One example embodiment comprises a method for dynamically changing the slice criteria in real time during full and incremental backups based on the number of files and their size in a single folder. One embodiment may focus more on creating smaller slices, also referred to as ‘sub-slices,’ out of a single slice to achieve the amount of parallelism desired by user for the backup.

One or more embodiments are concerned with on incremental backups leveraging the functionality of the underlying filesystem to enhance the sub-slicing logic for incremental backups. When a slicer according to an embodiment performs sub-slicing, during incremental backup of a sub-slice, one challenge is that file changes are unordered. In order to solve this problem, an embodiment may use an inode number for sequencing, or lexical search, of the file changes, which may be referred to as 'deltas' since an incremental backup may backup only changes to a file, rather than the entire changed file. According to an embodiment, during incremental backup, the deltas are distributed across sub-slices, thus maintaining the order of the deltas based on inode or file name sequencing. Dynamic sub-slicing and intelligent parallelism according to one embodiment may comprise the following operations, which may be performed by a slicer and data mover agent:
1. while scanning a directory, the slicer keeps count of the number of files scanned and if the number of files becomes greater then certain threshold (for example, 1 million), the slicer records that number of files in cache or temporary database;
2. similarly, and/or if any file is greater then the default slice size (for example > 200 GB), the slicer records that file as a separate sub-slice in cache or temporary database;
3. further, when a data mover agent process the slices and finds any sub-slice, the files of those sub-slices are read by the data mover agent from the cache or temporary database, rather than requiring performance of another scan by the slicer or data mover agent;
4. the data mover agent process sub-slices in parallel threads with the same number of parallel streams as selected by user (for example, if the user selects 5 parallel streams, the data mover agent will implement 5 parallel processing threads for the sub-slices); and
5. the data mover agent intelligently maintains the desired parallelism by running only that many slices and sub-slices in parallel as desired by the user.

B. Detailed description of aspects of an embodiment

It was noted earlier that, in conventional approaches, slices are created based on size of the folder or number of files inside a folder. For example, a folder with 200 GB of data is carved out to make up 1 slice, similarly, a folder with greater then 1 million of files is carved out to make up 1 slice. By way of contrast, in order to break slices into multiple sub-slices and backup those sub-slices with desired parallelism, a number of methods according to various embodiments may be employed.

### B.1 Scan filesystem once for slicing and data backup

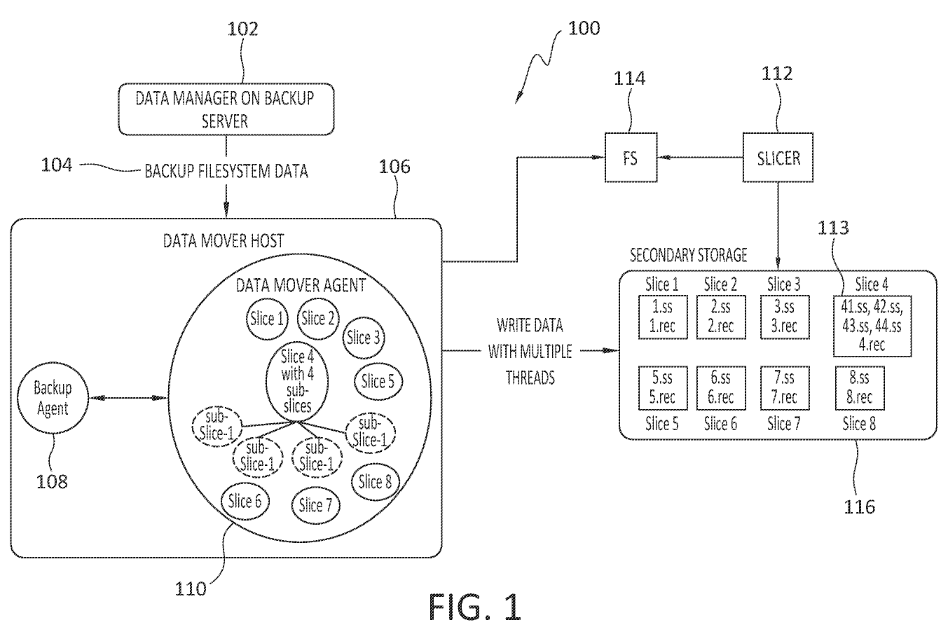

With reference now to FIG. 1, an example schema 100 according to an embodiment is disclosed. By way of overview, a data manager 102 hosted on a backup server may generate and transmit a backup request 104 to a data mover host 106. The data mover host 106 may comprise a backup agent 108 that communicates, and my operate in conjunction with, a data mover agent 110. A slicer 112 may generate and/or obtain metadata 113 concerning the crawled or scanned data included in slices generated or defined by the slicer 112, that is, the data stored in a filesystem 114 by the slicer 112, in a secondary storage 116, such as a cache or temporary database. The secondary storage 116 may be shared between multiple consumers such as, the slicer 112, or agent, creating slices, and the data mover agent 110. Sub-slices make up a very light weight database which is kept in a memory of the slicer 112 during the slicing operation and later moved to the secondary storage 116 temporarily to be used by the data mover agent 110.

In an embodiment, the data mover agent 110 determines whether to scan the files from the filesystem 114, or get the file information from a temporary sub-slice database from the secondary storage 116 based on the number of files in a single slice. In an embodiment, the sub-slice database contains very limited information but enough information, which may comprise metadata, to enable the data mover agent 110 to locate the file on the filesystem 114. Such information may include, for example, inode number, dirent offset, dirent name, and dirent length.

It is noted that a dirent structure may be employed, in one embodiment, to store the aforementioned filesystem information concerning the files. While a dirent structure is specific to Linux systems, the scope of this disclosure is not limited to any particular system or data/metadata storage structures. Thus, reference herein to dirent structures, and entries in dirent structures, is made only by way of example, and not limitation.

1. if slice information resulting from a scan performed by the slicer 112 records the number of files as more then 1 million, the data mover agent 110 finds the sub-slice information, which may reside in the secondary storage 116, and may start reading the file details from a, temporary, sub-slice database in the secondary storage 116, and then read actual data for backup from the mounted filesystem 114; or

2. if the average file size in a slice is > 300 GB, then the data mover agent 110 may start reading file information from sub-slice database.

In an embodiment, the sub-slicing is done dynamically such that the cache should not overflow due to large size of the temporary sub-slice database. For example,
1. the metadata size for 10 million files is around 1 GB and if 8 such slices are shared to the data mover agent 110, this will make the data mover host 106 run out of memory when it reads all slices data together in 8 parallel threads;
2. thus, these slices are each divided into multiple sub-slices so that, advantageously:
   a. the data mover agent 110 reads smaller sub-slice files even if it creates – for example – 8 threads in a pool, and is able to control the usage of data mover host 106 memory; and
   b. the data mover agent 110 reads data of each sub-slice with multiple threads and uses the available data streams for backup.

### B.2 Method for sub-slicing high density folders

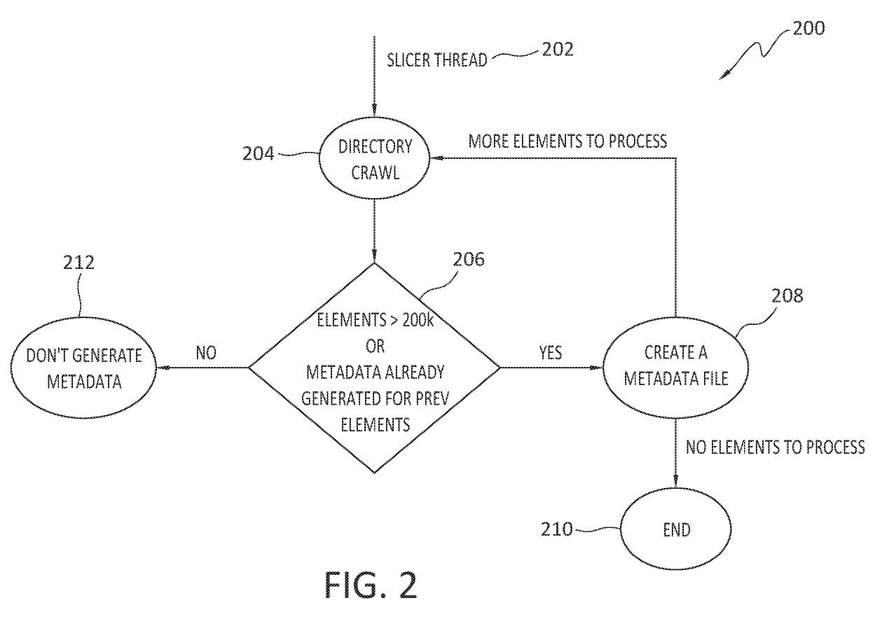

With reference now to FIG. 2, an example method 200 is disclosed for scanning high density folders, that is, folders with a relatively large number of files. As shown in the example of FIG. 2, a slicer may, when executing a slicer thread 202, crawl 204 a file system and create sub-slices out of a highly dense folder, or a slice while crawling 204 a filesystem, based on number of files or size of files.

In particular, the slicer may, as part of the directory crawl 204, scan each folder of the directory and for each entry in the directory, such as a file or folder for example, the slicer gathers information such as inode number, dirent name, dirent length, and dirent offset, and saves that information in an in-memory database, one example of which is SQLite. The aforementioned dirent structure details may be stored in and in-memory database file.

The slicer keeps a count of the number of dirent entries encountered during the directory crawl 204 and if it is determined 206 that the count of dirent entries exceeds a threshold, such as 200k entries for example, then the slicer may create a metadata file, or database file, and move that metadata file temporarily to secondary storage, at which point the method of the schema 200 may end 210. On the other hand, if it is determined 206 that the count of dirent entries does not exceed the threshold, no additional metadata is generated 212, and the database file may be cleared from memory.

In an embodiment, a slicer runs with a predefined thread pool size, such as 32 scan threads for example. The number of threads may be computed dynamically, such as during an incremental backup for example, depending on the amount of available data mover host (see reference 106 in FIG. 1) memory. For example, a slicer may, in one scenario, use only 1/8th of the data mover host memory. In this example, 1 thread requires 25 MB of memory for 200K files, so 32 threads will use ~1 GB of memory (25 MB * 32) to store a database for 32 scan threads in memory. In an embodiment, a slicer maintains a global map in a database of all sub-slices to enable the data mover agent to know the sub-slices information during data backup. These sub-slice temporary databases may be deleted after each backup completion.

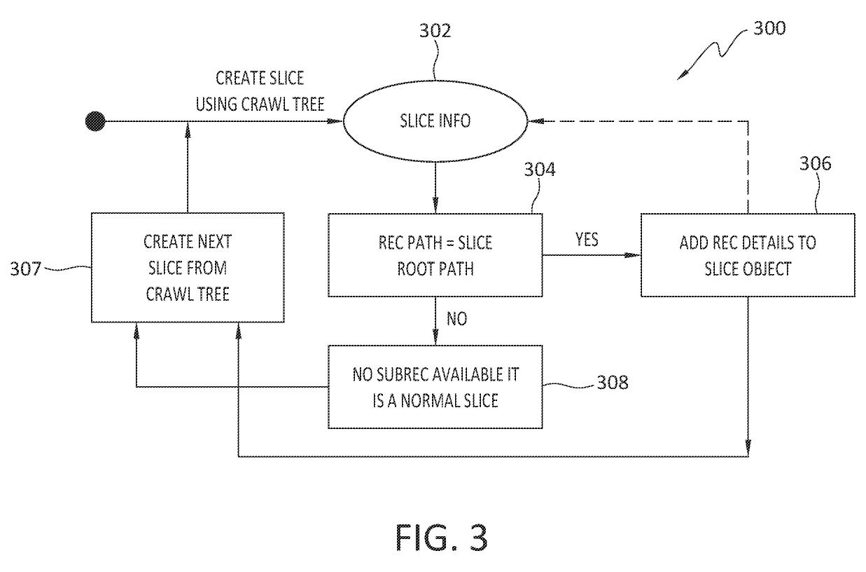

Turning next to FIG. 3, an example method 300 is disclosed for slice creation, such as may be performed by a slicer while the slicer is scanning a filesystem or other repository of files. The slices may be created through use of a crawl tree that may be used to guide the slicer through a filesystem. When a slice has been identified by the slicer, slice information may be created 302. As noted earlier, such slice information may comprise information such as inode number, dirent name, dirent length, and dirent offset.

A check 304 may then be performed to determine if the file record path is the same as the slice root path. If so, record details may be added 306 to the slice object, and the method 300 may continue to 307 where the next slice is created using the crawl tree. On the other hand, if it is determined 304 that the file record path is not the same as the slice root path, then it can be deemed 308 that no sub-record is available, and the slice is a normal slice. The method may then proceed to 307.

### B.3 Method for sub-slicing low density folders

Attention is directed now to an example method for sub-slicing low density folders, that is, folders with only a few, or one, file. In this example method, a slicer creates sub-slices out of a folders which have very large size files, for example, a file size of 300 GB found during crawling and creates sub-slices out of that slice. The slicer scans each folder and for each entry, such as a file or folder, the slicer gathers information such as inode number, dirent name, dirent length, and dirent offset.

If any file in the folder is greater then the default slice size threshold, such as 200 GB ± 30 percent for example, then the slicer records that entry in an in-memory database, such as SQLite for example. All the above dirent structure details may be stored in in-memory database file.

The slicer may continue to scan the folder and keep adding information about the large files into a separate in-memory database. As well, the slicer may also keep counting the number of entries and if that same folder has very high number of files, the slicer may apply the same method as described above to create sub-slices for those files as well.

In an embodiment, the slicer keeps a count of number of dirent entries and if the count exceeds high threshold, such as 200k entries for example, the slicer may move the database file temporarily to secondary storage, or otherwise cleanup the database file from memory. The slicer may maintain a global map in a database of all sub-slices for data mover agent to know the sub-slices information during data backup. These sub-slice temporary databases are deleted after each backup completion.

### B.4 Backup sub-slices with desired parallelism

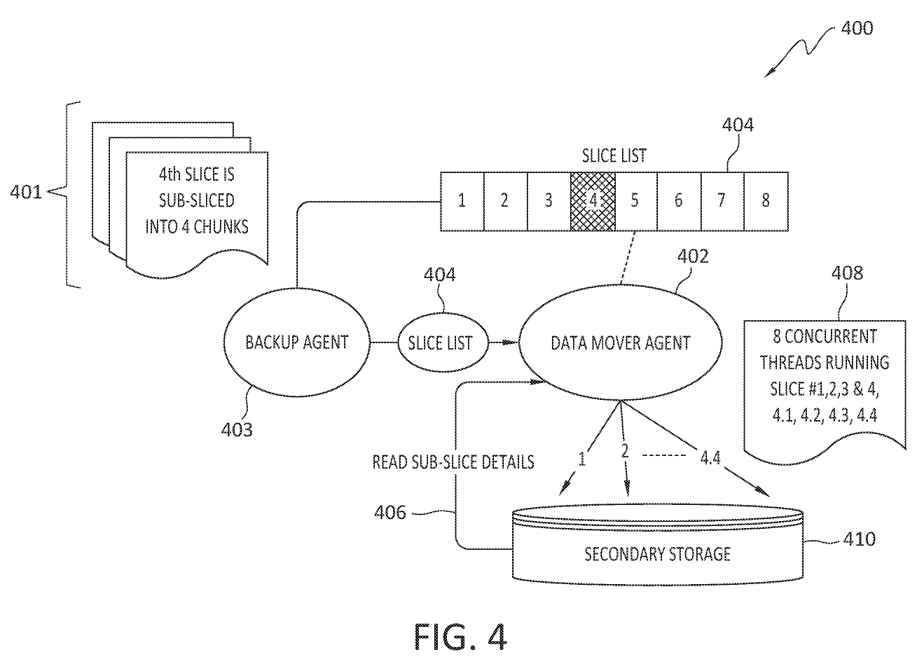

With reference now to FIG. 4, an example method and schema, collectively denoted at 400, for backing up sub-slices is disclosed. In particular, once all the slices and sub-slices, shown at 401, are created, the data mover agent 402 receives, from the backup agent 403, the slice list 404 and the details of the sub-slices, if any, in a machine readable file, such as a .JSON (JavaScript Object Notation) file for example. This file may contain information such as, but not limited to, the asset name (name of asset whose data is being backed up), number of slices, number of files in each slice, path of sub-slices, and the number of desired parallel streams.

Various further operations of the method 400, which may be performed in whole or in part by the data mover agent, may comprise the following
1. read the JSON file and retrieve the file information;
2. find the number of total slices from the slice list 404;
3. check 406 for details about any sub-slice in each slice detail;
4. create a thread pool 408 with the same number of threads as the desired parallelism for the backup session;
5. execute slice or sub-slices to the thread pool 408 which may reside in a secondary storage 410;
6. a new slice or sub-slice may be added to the thread pool 408 as soon as a slice or sub-slice is completed:
   a. this may ensure that data is being backed up with the same parallelism as desired by a customer; and
   b. this may ensure that no data stream is left empty until all slices or sub-slices are completed for backup;
7. Each slice and sub-slice written to a separate data container;
8. all sub-slices may be merged to a single data container after immediate backup or periodically, for example, after every 2 weeks, or every 14th backup;
9. this merge may be done to minimize the number of files on secondary storage; and
10. metadata for each sub-slice is maintained in a single database file, which may be stored in the secondary storage 410.

It is noted that another approach for implementing the desired backup parallelism may be driven from a control path, where this approach may send slices 401 with multiple chunks in a separate job along with a desired parallel stream. This may reduce the wait queue for the data mover agent 402 for other slices 401.

### B.5 Handling a sub-slice as a slice

In light of some of the issues noted herein with respect to a sub-slice, one embodiment may operate to handle a sub-slice as a slice. Since a change-file list is available and accurate for a high-density directory, if the delta changes are correctly notified to corresponding slices, then making a sub-slice as a slice may solve scale out, read-stream limit, disk size and indexing issues. As for other arrays, since a change file list is not available, a sub-slice may continue as a sub-slice, but an enhancement may be implemented so as to read file system metadata records and identify a changelist in NASAGENT (network attached storage agent), bringing the delta finding mechanism in NASAGENT and then distributing the delta for the corresponding slice.

The following example is illustrative. Suppose the directory /testdir/F1 has 20 million files. If 20 slices are created from that directory, during incremental backup, it may be necessary to identify which slice the particular file /testdir/F1/testfile.txt has gone to if that file has been modified or deleted, so that the corresponding CDSF (common data streaming format) will be updated with this information.

B.5.1 Considerations for changing/treating a sub-slice as a slice
1. The high-density folder is scanned and the readdir call does not ensure any order of the files in a directory.
2. The large number of files may need to be divided as separate slice(s), and many such slices will be backed up using different tasks spanning across different proxy VMs (virtual machines).
3. During incremental backup time, the file information may be needed to identify which slice that file belongs to.
4. The HDF slice may maintain an order based on a file system property.
5. To make a sub-slice as slice, the ordering of files should be maintained – in an embodiment, this may only be achieved once the entire directory is scanned and put into a single SQLite, and then an order based small SQLite may be created and identified as a representation of an HDF slice.
6. The slice object may have two more fields: [1] first file name and [2] last file name, these two names may be used to find a delta suitable to go to a particular slice.
7. Keeping the whole crawl data at the beginning will create disk-space challenge. Thus, only filename and size may be added in the local SQLite.
8. The filesystem may receive a slice having HDF files into stored in a SQLite DB in data domain – no stat data will be shared beyond filename and modification type (this field is just placeholder for Gen0 backup keeping consistency of data sharing for Gen0 and Gen1 backups).
9. Index on file name column will be carried out to get smaller chunks in a sorted order with fixed file count as threshold (for example, 100k files per slice for HDF folders) or summation meets the size criteria.

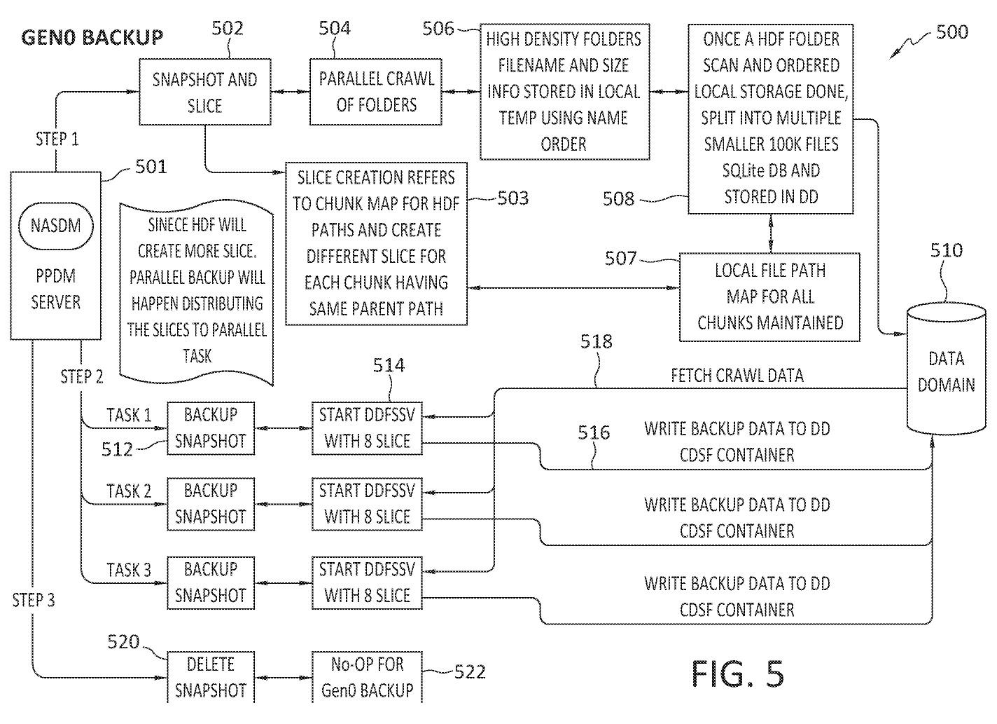

With attention now to FIG. 5, an example method 500 for handling a sub-slice, as a slice, in a Gen0 backup, is disclosed. In an embodiment, the method 500 may be implemented in connection with a Dell Technologies PowerProtect Data Manager (PPDM) server 501 that hosts a NASDM (network attached storage data manager), but that is not required in any embodiment.

In an embodiment, and as shown at ‘Step 1,’ a snapshot may be taken 502 of a dataset, and the snapshot divided into slices. Folders of the snapshot may be crawled 504, or scanned, in parallel by a data slicer. As part of the crawl 504, or after, HDF filenames and sizes may be stored 506, in order with respect to each other, in a temporary local location, such as cache memory. Next, the files of the HDF may be split 508 into chunks, such as chunks of 100k size, which may then be stored in a data protection platform 510, such as the Dell Technologies DataDomain.

With continued reference to ‘Step 1,’ the slice creation process 502 may refer 503 to a chunk map for HDF paths, and may create different slices for each chunk that has the same parent path in the HDF. A local file path map may be maintained 507 for these chunks.

As shown in ‘Step 2’ in FIG. 5, the server 501 may perform a number of tasks in parallel with each other. Each of these tasks may comprise taking a backup snapshot 512. A utility, such as the Dell Technologies ‘ddfssv’ utility for example, may be invoked 514 to perform a respective save operation for each of the snapshots that was created 512.

The snapshots, and their associated metadata, may then be written 516 to the data protection platform 510. In an embodiment, the snapshots and metadata may be written to a Dell Technologies DataDomain CDSF container, although that particular container type is not required in any embodiment.

With continued reference to FIG. 5, the crawl information obtained at 506, and stored in the data protection platform 510, may be accessed and retrieved 518 by the server 501 for use in a slicing operation directed to the snapshot(s) created at 512. In an embodiment, a saved snapshot may be sliced, by default, into 8 slices, although no particular number of slices is necessarily required in any embodiment.

Finally, in ‘Step 3’ of FIG. 5, the data protection platform 510 may delete 520 one or more snapshots. Since FIG. 5 discloses an example of a Gen0 backup, there may be no existing snapshots, as shown at 522.

B.6 Example schemas, tables, and other mechanisms

B.6.1 SQLite schema for HDF slice file details sharing

An embodiment of a slicer may employ a ‘type’ as a character to denote new entry (N), Deleted Entry (D), Modified Entry (M). Keeping only one char will require less space when file entries number in the millions or more. In an embodiment, a SQLite index operation may be performed on a per-FileName basis so as to generate an indexed table that enables data fetches in a faster, sorted, order. This same schema may be used for Gen0 HDF slice, as well as during incremental backup for sharing delta per slice.

B.6.2 Slice object contract for filesystem communication

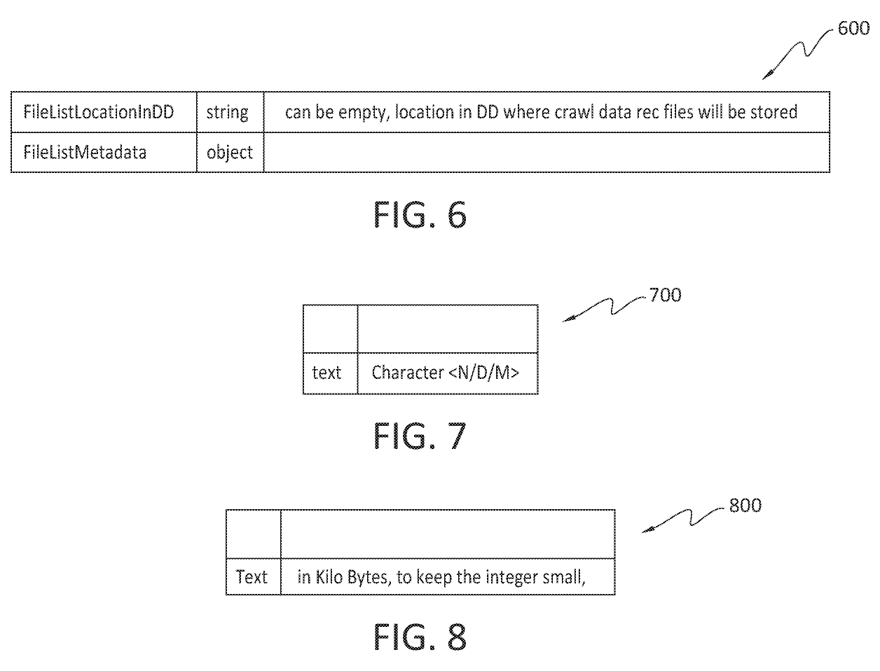

With reference to the example schema 600 of FIG. 6, an embodiment may not require any change in an existing slice object contract. Moreover, crawl data may be shared using the existing two fields of FileListLocationInDD and FileListMetadata, which are used in one embodiment for sub-slice information sharing. It is noted that while the aforementioned fields are specific to the Dell Technologies DataDomain platform, they are not required to be used, and other fields may be used that are appropriate for different platforms.

B.6.3 SQLite schema shared with filesystem

As shown in the example schema 700 of FIG. 7, an embodiment may employ a table name crawl_data. This table may include the field ‘Text’ and may list the appropriate characters for a new entry (N), deleted entry (D), and modified entry (M).

B.6.4 Internal SQLite at NASAGENT for HDF folder scan during Gen0

Turning next to FIG. 8, an example schema 800 is disclosed which may take the form of a table having the name crawl_data. In an embodiment, a FileName may be specified: in local temp with pathNamehash.rec (one way hash); hex (FNV1(path))_hex(threadid)_hex(timestamp) /md5_hex(threadid)_hex(timestamp); max size 128 char. In an embodiment, this file will be deleted once a smaller SQLite DB, such as 100K, is created out of this temporary one. The size filed will be used to create a slice if the criteria of 100K or 200GB, for example, is met.

B.6.5 SQLite query sample for creating HDF slice post-crawling

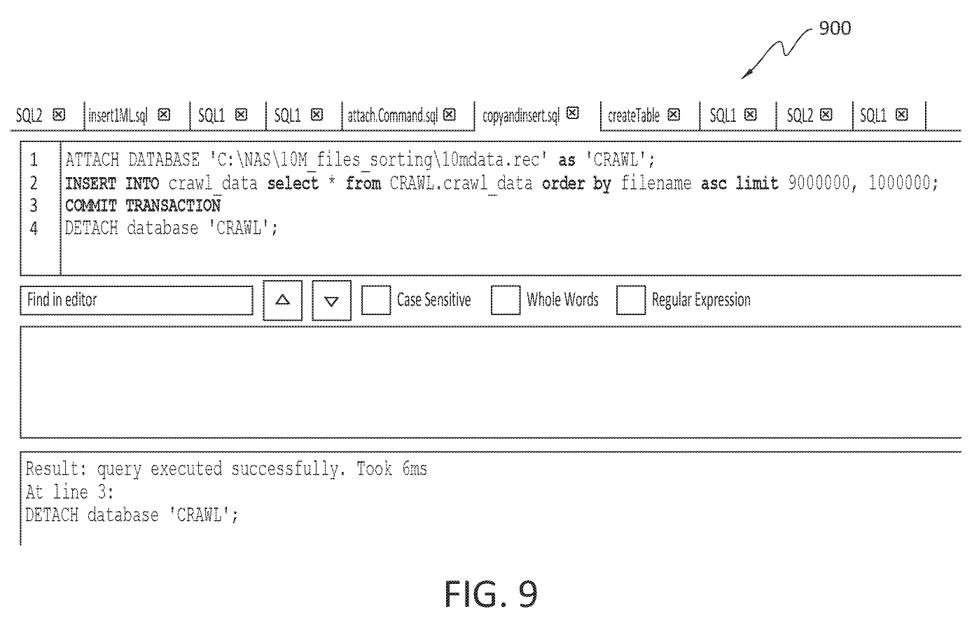

With reference now to FIG. 9, a sample query 900 such as may be defined and run according to one embodiment is disclosed. In this example, HDF folders will be crawled and saved in a local temporary location in a single SQLite, at least initially. Then, a 100k file count based smaller SQLite may be created, and each 100k files will represent a different slice. The particular example of FIG. 9 indicates 100k files SQLite creation from a 10m (ten million) files SQLite crawl database.

One example embodiment may have relatively low disk space requirements. In particular, using the example schema of only file name and file size for 10 million files with average filename length (64 character0 would consume only 1.5GB disk space. There could extreme cases, such as if the total number of files in a directory are > 200 million and average filename lengths are 255 char and beyond, then current vProxy (Dell Technologies vProxy appliance) configured disk allotment may not suffice, and would require an extended disk partition to support such constraints.

### C. Further discussion

As disclosed herein, one or more embodiments may possess various useful features and aspects, although no embodiment is required to possess any of such features or aspects. The following examples are illustrative, but not exhaustive.

An embodiment may use inode number or file name sequencing, that is, lexical order, to identify the respective deltas for incremental backups. An embodiment may comprise a data mover agent that intelligently maintains the desired parallel streams for slice and their sub-slices. An embodiment may dynamically compute, based on amount of data mover host memory, a number of threads for creating sub-slices. Finally, an embodiment may implement a single backup metadata DB that contains the metadata for all sub-slices in a one-to-many, that is, one slice-to-many sub-slices, relationship which enables indexing as composite operation for FLR and enables seamless incremental backup for slices and sub slices. Thus, an embodiment may implement and use a mechanism to reduce the metadata growth generation on secondary storage. Moreover, in an embodiment, every backup is not synthesized and synthesis may be performed periodically after a certain threshold, of a number of incremental backups taken, has been met.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments. These are presented only by way of example and are not intended to limit the scope of this disclosure or the claims in any way.

Embodiment 1. A method, comprising: while an incremental backup of files is being performed, scanning, by a slicer, a directory that includes the files; keeping a count of the files that have been scanned; determining, by the slicer, when a file size threshold, or a file number threshold, has been exceeded; and when the file size threshold, or the file number threshold, has been exceeded, recording, by the slicer, as a sub-slice, those file(s) that were the basis for the determination that one of those thresholds had been exceeded.

Embodiment 2. The method as recited in any preceding embodiment, wherein the incremental backup comprises a backup of file deltas that are distributed across one or more other sub-slices in such a way that sequencing of the file deltas is maintained.

Embodiment 3. The method as recited in any preceding embodiment, wherein the sub-slice is recorded in a cache or a temporary database.

Embodiment 4. The method as recited in any preceding embodiment, wherein sub-slices are created by the slicer using threads, and a number of the threads is dynamically determined based on an amount of memory available in a host of a data mover.

Embodiment 5. The method as recited in any preceding embodiment, wherein a data mover agent maintains a selected number of parallel streams for performing the incremental backup of files included in the sub-slice, and one or more other sub-slices.

Embodiment 6. The method as recited in any preceding embodiment, wherein metadata of the sub-slice is stored in a single database that stores metadata for all sub-slices of a slice that includes the sub-slice.

Embodiment 7. The method as recited in any preceding embodiment, wherein the incremental backup is synthesized with one or more other incremental backups after a threshold has been met that specifies a number of incremental backups that should be synthesized.

Embodiment 8. The method as recited in any preceding embodiment, wherein a data mover agent processes the sub-slice, along with one or more other sub-slices and, when the data mover agent, finds any sub-slice, files of those sub-slices are read by the data mover agent from a cache or a temporary database.

Embodiment 9. The method as recited in any preceding embodiment, wherein a data mover agent backs up the sub-slices, along with one or more other sub-slices, in parallel with a same number of parallel streams specified by a user.

Embodiment 10. The method as recited in any preceding embodiment, wherein the file size threshold and the file number threshold comprise criteria that are automatically changed by the slicer based on a file size, and a number of files, in a given folder.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

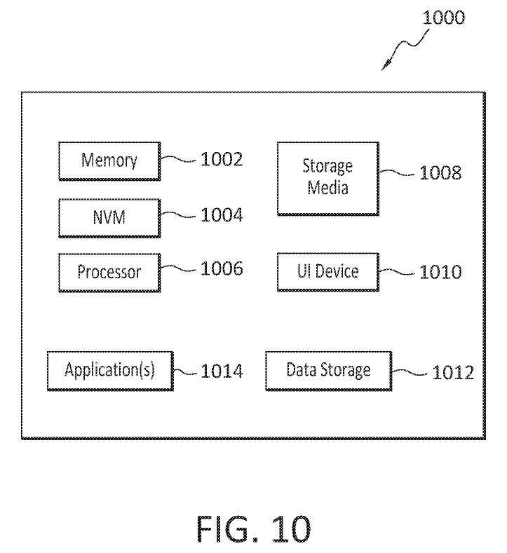

With reference briefly now to FIG. 10, any one or more of the entities disclosed, or implied, by FIGS. 1-9, and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI device 1010, and data storage 1012. One or more of the memory components 1002 of the physical computing device 1000 may take the form of solid state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
while an incremental backup of files is being performed, scanning, by a slicer, a directory that includes the files;
keeping a count of the files that have been scanned;
determining, by the slicer, when a file size threshold, or a file number threshold, has been exceeded; and
when the file size threshold, or the file number threshold, has been exceeded, recording, by the slicer, as a sub-slice, those file(s) that were the basis for the determination that one of those thresholds had been exceeded.

2. The method as recited in claim 1, wherein the incremental backup comprises a backup of file deltas that are distributed across one or more other sub-slices in such a way that sequencing of the file deltas is maintained.

3. The method as recited in claim 1, wherein the sub-slice is recorded in a cache or a temporary database.

4. The method as recited in claim 1, wherein sub-slices are created by the slicer using threads, and a number of the threads is dynamically determined based on an amount of memory available in a host of a data mover.

5. The method as recited in claim 1, wherein a data mover agent maintains a selected number of parallel streams for performing the incremental backup of files included in the sub-slice, and one or more other sub-slices.

6. The method as recited in claim 1, wherein metadata of the sub-slice is stored in a single database that stores metadata for all sub-slices of a slice that includes the sub-slice.

7. The method as recited in claim 1, wherein the incremental backup is synthesized with one or more other incremental backups after a threshold has been met that specifies a number of incremental backups that should be synthesized.

8. The method as recited in claim 1, wherein a data mover agent processes the sub-slice, along with one or more other sub-slices and, when the data mover agent, finds any sub-slice, files of those sub-slices are read by the data mover agent from a cache or a temporary database.

9. The method as recited in claim 1, wherein a data mover agent backs up the sub-slices, along with one or more other sub-slices, in parallel with a same number of parallel streams specified by a user.

10. The method as recited in claim 1, wherein the file size threshold and the file number threshold comprise criteria that are automatically changed by the slicer based on a file size, and a number of files, in a given folder.

11. A non-transitory storage medium having stored therein instructions that are executable by one or more hardware processors to perform operations comprising:
while an incremental backup of files is being performed, scanning, by a slicer, a directory that includes the files;
keeping a count of the files that have been scanned;
determining, by the slicer, when a file size threshold, or a file number threshold, has been exceeded; and
when the file size threshold, or the file number threshold, has been exceeded, recording, by the slicer, as a sub-slice, those file(s) that were the basis for the determination that one of those thresholds had been exceeded.

12. The non-transitory storage medium as recited in claim 11, wherein the incremental backup comprises a backup of file deltas that are distributed across one or more other sub-slices in such a way that sequencing of the file deltas is maintained.

13. The non-transitory storage medium as recited in claim 11, wherein the sub-slice is recorded in a cache or a temporary database.

14. The non-transitory storage medium as recited in claim 11, wherein sub-slices are created by the slicer using threads, and a number of the threads is dynamically determined based on an amount of memory available in a host of a data mover.

15. The non-transitory storage medium as recited in claim 11, wherein a data mover agent maintains a selected number of parallel streams for performing the incremental backup of files included in the sub-slice, and one or more other sub-slices.

16. The non-transitory storage medium as recited in claim 11, wherein metadata of the sub-slice is stored in a single database that stores metadata for all sub-slices of a slice that includes the sub-slice.

17. The non-transitory storage medium as recited in claim 11, wherein the incremental backup is synthesized with one or more other incremental backups after a threshold has been met that specifies a number of incremental backups that should be synthesized.

18. The non-transitory storage medium as recited in claim 11, wherein a data mover agent processes the sub-slice, along with one or more other sub-slices and, when the data mover agent, finds any sub-slice, files of those sub-slices are read by the data mover agent from a cache or a temporary database.

19. The non-transitory storage medium as recited in claim 11, wherein a data mover agent backs up the sub-slices, along with one or more other sub-slices, in parallel with a same number of parallel streams specified by a user.

20. The non-transitory storage medium as recited in claim 11, wherein the file size threshold and the file number threshold comprise criteria that are automatically changed by the slicer based on a file size, and a number of files, in a given folder.
